(19) United States
(12) Patent Application Publication
(10) Pub. No.: US 2007/0060087 A1
(43) Pub. Date: Mar. 15, 2007

(54) Low noise high linearity downconverting mixer

(76) Inventor: Zhaofeng Zhang, Shanghai (CN)

Correspondence Address: LAW OFFICES OF CLEMENT CHENG, 17220 NEWHOPE STREET #127, FOUNTAIN VALLEY, CA, 92708, US

(21) Appl. No.: 11/223,345

(22) Filed: Sep. 10, 2005

(51) Int. Cl. H04B 1/18

(52) U.S. Cl. 455/190.1; 455/313

(57) ABSTRACT

This invention presents a low noise high linearity downconverting mixer, comprising a switch circuit, an intermediate frequency IF circuit, a RF amplifier circuit, and a DC bias current circuit, whereas the present invention is used at RF front end in wireless communication devices.

### FIELD OF THE INVENTION

The present invention relates to a low noise high linearity downconverting mixer, and more particularly to a mixer in the receiving device of a wireless radio frequency system.

### BACKGROUND OF THE INVENTION

It is well known that mixer is one of the essential components among wireless RF system devices. Commonly mixer is used to convert a RF input signal into an intermediate frequency (IF) signal without signal distortion. It is so required a better system linearity, low noise and high amplified ratio. Linearity is an important specification to measure the quality of a mixer. In the traditional Gilbert mixer, as shown in FIG. 1, when the input high RF signal is on the negative phase, since the reference current is zero, it may turn MOS transistors M₁ and M₂ off, causing poor linearity. Also since the current via transistors are strong, loading resistance must not be high. It limits the system gain in a mixer, while having bad noise causing from transistors.

### BRIEF DESCRITION OF THE DRAWINGS

FIG. 1 is a circuit diagram of a prior art Gilbert Mixer;

FIG. 2 is a circuit diagram of a low noise and high linearity downconverting mixer circuit in present invention;

FIG. 3 is a circuit schematic of a switch circuit and an intermediate frequency circuit of a low noise high linearity downconverting mixer in present invention;

FIG. 4 is a circuit schematic of a RF amplifier circuit of a low noise high linearity downconverting mixer in present invention;

FIG. 5 is a circuit schematic of a DC current source circuit of a low noise high linearity downconverting mixer in present invention;

FIG. 6 is a circuit diagram.

### SUMMARY OF THE INVENTION

The purpose of the present invention is to introduce a low noise high linearity downconverting mixer circuit having a higher linearity, better system gain, and lower system noise.

The above purpose of present invention can be implemented as follows: A low noise high linearity downconverting mixer consists of a switch circuit, an intermediate frequency circuit, a RF amplifier circuit, and a bias current circuit. A DC current source is inserted in between the switch circuit and the intermediate frequency circuit to reduce the current through transistors. Such design, under a guaranteed steady voltage drop on the loading resistance, allows a higher resistance value, improving the circuit gain. Also due to current reduction, system noise from transistors is reduced as well. The RF amplifier adopts a class AB structure, providing a DC reference current to input RF signal through a follower. Under such design the switch transistor is on which increases the linearity of the mixer circuit during input high RF signal and on the negative phase.

### DETAILED DESCRIPTION OF THE PREFERRED EMBODIMENT

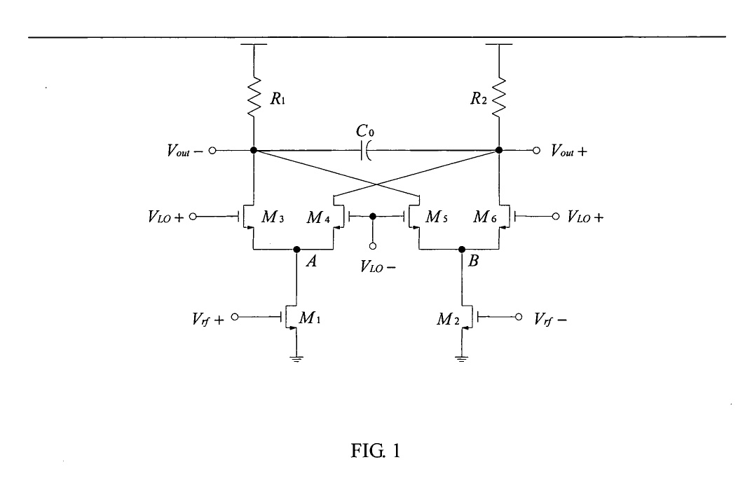

As shown in FIG. 1, the prior art Gilbert mixer circuit, having transistors M₃, M₄, M₅ and M₆ as switches, causes a very larger current through transistors. The circuit gain is limited as the loading resistance in this design cannot be high due to this very large current. Particularly when RF signals travel to transistors M₁ and M₂, M₁ and M₂ are possibly turned off when the input high RF signals are on the negative phase, causing distortion and directly affecting the quality of a mixer.

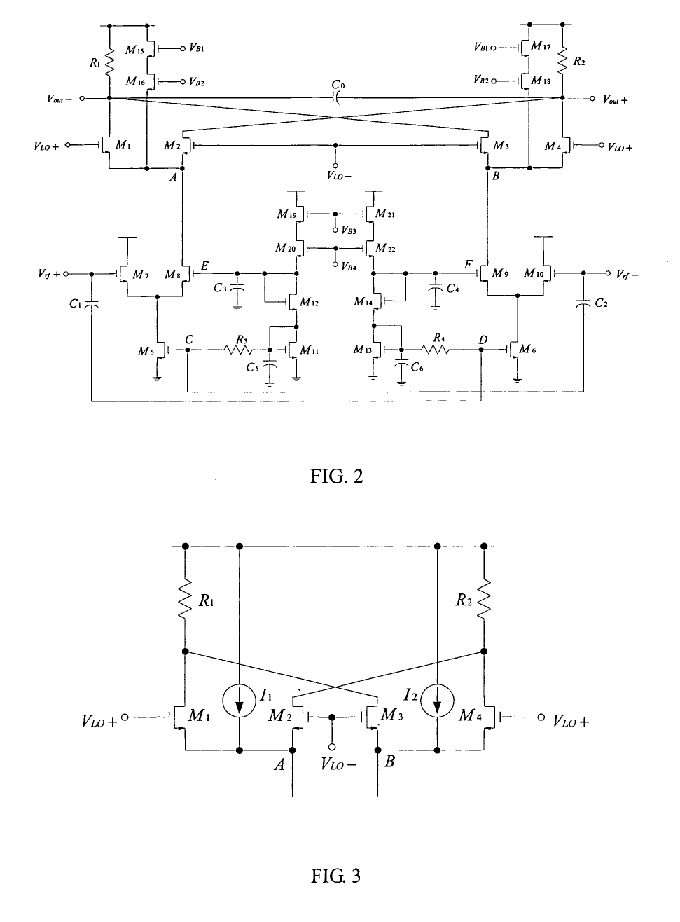

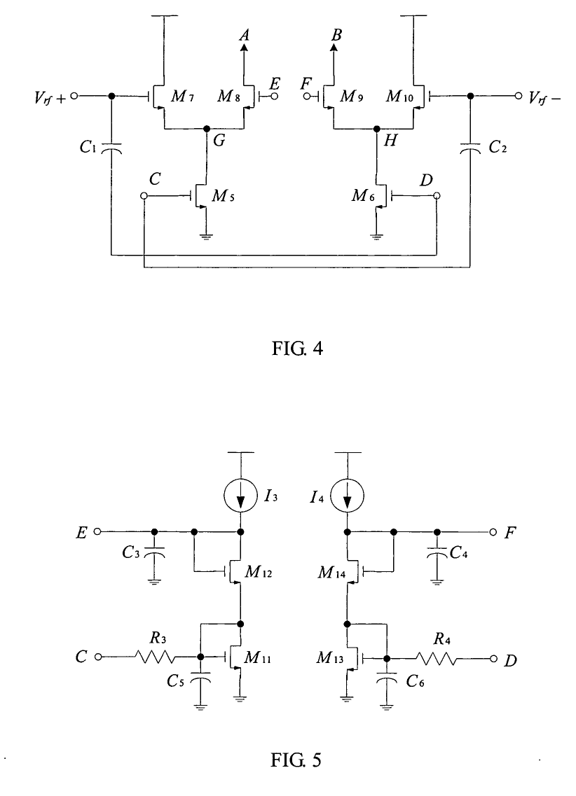

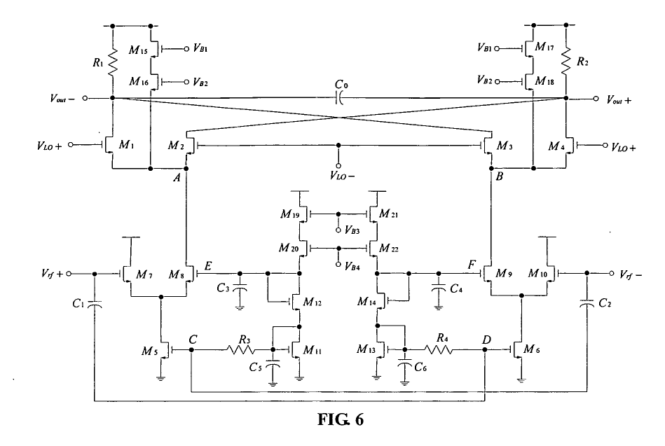

FIG. 2, FIG. 3, and FIG. 4 all show the low noise high linearity downconverting circuit in the present invention including the switch circuit, the intermediate frequency circuit, and the RF amplifier circuit. As shown in FIG. 2 and FIG. 3, the switch circuit and the intermediate frequency circuit are constructed by transistors M₁, M₂, M₃, M₄, DC current sources I₁, I₂, and resistance elements R₁, R₂. Such circuit connects to transistors M₈ M₉ at terminals A and B, while the followers M₇, M₁₀ connect to current sources M₅, M₆ and capacitors C₁, C₂.

As shown in FIG. 4, voltage at terminals E and F follow with the input voltage values on V_{rf+}, V_{rf-}, Voltage values on V_{rf+}, V_{rf-} are in opposite phases. Transistors M₈ and M₉ convert RF input signals into current signals, while gate terminals voltage (E and F) are provided by DC bias circuit. When input voltage V_{rf+} rises, V_{rf-} is reduced, when terminal E voltage turns higher, M₈ current becomes low, as M₅ current reduces when V_{rf-} voltage turns low. Voltage on terminal F turns low following with V_{rf-} voltage, M₉ current increases, as M₆ current also increases following with V_{rf+} voltage, and vise versa.

FIG. 5 shows the DC bias circuit in FIG. 2. The DC bias circuit having DC current source I₃ connecting with transistors M₁₂ and M₁₁, also having capacitors C₃ and C₅ as signal filters, and resistance R₃ as isolation between RF signal and bias circuit. Capacitors are used for filtering the noise in the bias current. Similarly, DC current source I₄ connects with transistors M₁₄ and M₁₃, having capacitors C₄ and C₆ as signal filters, and resistance R₄ as isolation between RF signal and bias circuit.

The present invention, through implementation described above, can improve system linearity, improve system gain, and reduce system noise.

1. A low noise high linearity downconverting mixer comprising a switch circuit, an intermediate frequency circuit, a RF amplifier circuit, and a DC bias current circuit.

2. The downconverting mixer of claim 1 further including a DC current source in between the switch circuit and the intermediate frequency circuit.

3. The downconverting mixer of claim 1, wherein the RF amplifier circuit, using a class AB structure, provides a DC reference current to an input RF signal through a follower.

4. The class AB structure of RF amplifier of claim 3 further comprising a follower, an amplifier and a plurality of capacitors.

5. The downconverting mixer of claim 1, wherein the DC bias circuit comprises a plurality of transistors M₁₁, M₁₂, M₁₃, M₁₄, a plurality of DC current sources I₃,I₄, a plurality of fulting C₃, C₄, C₅, C₆ capacitors and a plurality of resistances R₃, R₄.

6. The downconverting mixer of claim 1, further comprising a DC current source which comprises switch transistors M₁, M₂, M₃, M₄, DC current source I₁, I₂, Resistor R₁, R₂ in between the switch circuit and intermediate frequency unit.

7. A low noise high linearity downconverting mixer comprising: a switch circuit, an intermediate frequency circuit, a RF amplifier circuit, and a DC bias current circuit, further including a DC current source between the switch circuit and the intermediate frequency circuit.

8. The downconverting mixer of claim 7, wherein the RF amplifier circuit, using a class AB structure, provides a DC reference current to an input RF signal through a follower.

9. The downconverting mixer of claim 7, wherein the DC bias circuit comprises a plurality of transistors M₁₁, M₁₂, M₁₃, M₁₄, a plurality of DC current sources I₃,I₄, a plurality of fulting C₃, C₄, C₅, C₆ capacitors and a plurality of resistances R₃, R₄.

10. The downconverting mixer of claim 7, further including a DC current source which comprises switch transistors M₁, M₂, M₃, M₄, DC current source I₁, I₂, Resistor R₁, R₂ in between the switch circuit and intermediate frequency unit.
